(19) United States
(12) Patent Application Publication
(10) Pub. No.: US 2009/0102382 A1
(43) Pub. Date: Apr. 23, 2009

(54) High-pressure discharge lamp

(76) Inventor: Frank Werner, Berlin (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/990,363

(22) PCT Filed: Aug. 4, 2006
(86) PCT No.: PCT/EP2006/007755

§ 371 Date: Feb. 11, 2008

(30) Foreign Application Priority Data
Aug. 11, 2005 (DE) 10 2005 038 350.5

(51) Int. Cl. H01J 61/073

(52) U.S. Cl. 313/631

(57) ABSTRACT

A high-pressure discharge lamp which has a nominal output of less than 50 watt and is provided with a discharge vessel (11) that is made of silica glass and contains rod-shaped electrodes (13, 14) as well as an ionizable filling for generating a gas discharge, said ionizable filling comprising mercury, metal halides, and rare gas. The high-pressure discharge lamp features thicker electrodes (13, 14) than those used in generic high-pressure discharge lamps known in prior art. The thickness or the diameter of the electrodes (13, 14) of the disclosed high-pressure discharge lamps lies within a range of 0.255 millimeter to 0.350 millimeter in order to increase the life expectancy of the high-pressure discharge lamps.

The invention relates to a high-pressure discharge lamp in accordance with the precharacterizing clause of patent claim 1.

### I. PRIOR ART

Such a high pressure discharge lamp is disclosed, for example, in EP 0 786 791 A1. This document describes a high-pressure discharge lamp for a motor vehicle headlamp with a rated power of 35 watts and a discharge vessel made from quartz glass, in which two bar-shaped tungsten electrodes and an ionizable filling for producing a gas discharge are arranged, the ionizable filling comprising mercury, metal halides and noble gas. The bar-shaped electrodes in the case of such a high-pressure discharge lamp conventionally have a thickness or a diameter in the range of from 0.240 mm to 0.250 mm.

### II. DESCRIPTION OF THE INVENTION

The object of the invention is to provide a generic high-pressure discharge lamp which has a higher life expectancy.

This object is achieved according to the invention by the features of patent claim 1. Particularly advantageous embodiments of the invention are described in the dependent patent claims.

The high-pressure discharge lamp according to the invention with a rated power of less than 50 watts has a discharge vessel made from quartz glass with bar-shaped electrodes arranged therein and an ionizable filling, which comprises mercury, metal halides and noble gas, for producing a gas discharge. The bar-shaped electrodes of the high-pressure discharge lamp according to the invention have a thickness in the range of from 0.255 mm to 0.350 mm and are therefore markedly thicker than the electrodes of the high-pressure discharge lamp in accordance with the prior art, which have a thickness of only from 0.240 mm to 0.250 mm.

Surprisingly it has been shown that by using thicker electrodes with a diameter of up to 0.350 mm inclusive in the generic high-pressure discharge lamps, the life expectancy of these lamps can be markedly increased. If, however, electrodes with a diameter or a thickness of more than 0.350 mm are used in the generic high-pressure discharge lamp, an increased number of cracks occur during lamp operation in the discharge vessel as a result of the different coefficients of thermal expansion of the quartz glass and the electrode material, and these cracks can make the discharge vessel lose its seal tightness.

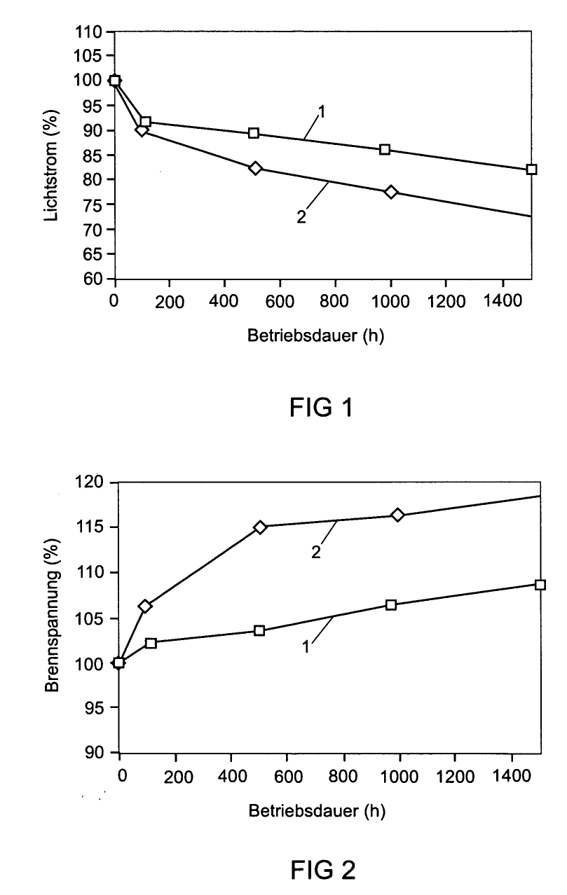

FIG. 1 illustrates the decrease in the luminous flux with the operating duration of the high-pressure discharge lamp for a high-pressure discharge lamp according to the invention and for a high-pressure discharge lamp in accordance with the prior art. The luminous flux as a percentage of the initial luminous flux of the respective high-pressure discharge lamp is plotted on the vertical axis in FIG. 1 as a function of the operating duration in hours. The measurement curve 1 shows the decrease in the luminous flux as a function of its operating duration for a high-pressure discharge lamp according to the invention, while the measurement curve 2 illustrates the decrease in the luminous flux as a function of its operating duration for a high-pressure discharge lamp in accordance with the prior art. It can be seen that the high-pressure discharge lamp according to the invention still has 83 percent of its initial luminous flux after an operating duration of 1500 hours, while the high-pressure discharge lamp in accordance with the prior art only still has 74 percent of its initial luminous flux after 1500 operating hours.

FIG. 2 illustrates, for the same high pressure discharge lamps, the profile of their running voltage as a function of their operating duration. The running voltage of a high-pressure discharge lamp is its operating voltage during so to speak steady-state lamp operation, after the end of its starting and runup phase. It is typically in the range of from approximately 80 volts to 100 volts. FIG. 2 illustrates, on the vertical axis, the running voltage as a percentage of its initial running voltage for the respective high-pressure discharge lamp as a function of its operating duration in hours. The measurement curve 1 in FIG. 2 shows the change in the running voltage as a function of its operating duration for the high-pressure discharge lamp according to the invention, while measurement curve 2 illustrates the change in the running voltage as a function of its operating duration for the high-pressure discharge lamp in accordance with the prior art. It can be seen that, in the case of the high-pressure discharge lamp according to the invention, the running voltage increases during operation to a lesser extent than in the case of the high-pressure discharge lamp in accordance with the prior art. The increase in the running voltage with the operating duration is caused by an increase in the electrode spacing, brought about by partial erosion of the electrodes, and by losses of filling constituents in the ionizable filling. The losses of filling constituents are, for example, the loss of sodium, brought about by diffusion of sodium ions to the discharge vessel wall, or the loss of scandium, brought about by a chemical reaction of the scandium with the quartz glass of the discharge vessel. The loss of sodium and scandium results in unbonded iodine in the discharge space, which causes a rise in the running voltage.

As shown in the illustrations in FIGS. 1 and 2 and in accordance with the above explanations, the high-pressure discharge lamp according to the invention has a lower decrease in the luminous flux and a lower rise in the running voltage over its operating duration in comparison with the high-pressure discharge lamp in accordance with the prior art. Correspondingly, the high-pressure discharge lamp according to the invention has a higher life expectancy than the high-pressure discharge lamp in accordance with the prior art.

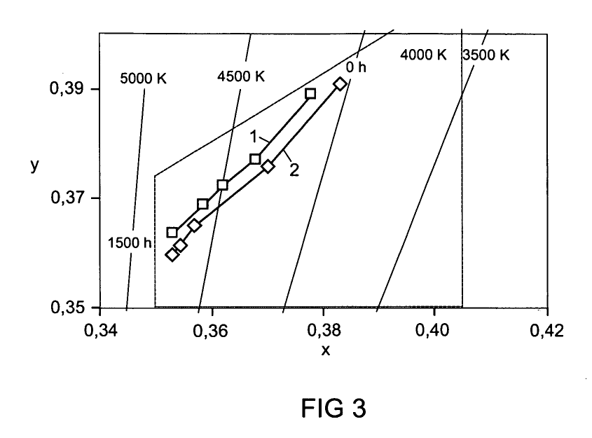

FIG. 3 illustrates, for the high-pressure discharge lamp according to the invention and the high-pressure discharge lamp in accordance with the prior art, in addition the change in color locus of the light emitted by these high-pressure discharge lamps as a function of the operating duration of these high-pressure discharge lamps. The axes of the graph in FIG. 3 correspond to the color coordinates x and y in accordance with the standard chromaticity diagram according to the DIN 5033. The color loci of the same color temperature for different color temperature values in the range of from 3500 kelvin to 5000 kelvin are illustrated in FIG. 3 by a plurality of straight lines. The curve 1 shows the displacement of the color locus as a function of the operating duration for the high-pressure discharge lamp according to the invention, while curve 2 illustrates the displacement of the color locus as a function of the operating duration for the high-pressure discharge lamp in accordance with the prior art. In this case, the same measurement points as in FIGS. 1 and 2 were evaluated, i.e. the measurements were carried out in each case after 0, 100, 500, 1000 and 1500 operating hours. According to curve 1 in FIG. 3, the color locus of the white light initially emitted by the high-pressure discharge lamp according to the invention at the color coordinates of x is approximately equal to 0.378 and of y is approximately equal to 0.39 and the initially emitted light has a color temperature of approximately 4200 kelvin. As the operating duration increases, the color locus of the light emitted by the high-pressure discharge lamp according to the invention is displaced to color loci with lower values for the color coordinates x and y and the color temperature of the emitted light increases to approximately 4700 kelvin after 1500 operating hours. According to curve 2 in FIG. 3, the color locus of the white light initially emitted by the high-pressure discharge lamp in accordance with the prior art at the color coordinates of x is approximately equal to 0.382 and of y is approximately equal to 0.39 and the initially emitted light has a color temperature of approximately 4100 kelvin. As the operating duration increases, the color locus of the light emitted by the high-pressure discharge lamp in accordance with the prior art is displaced to color loci with lower values for the color coordinates x and y and the color temperature of the emitted light increases to approximately 4700 kelvin after 1500 operating hours.

The electrodes of the high-pressure discharge lamp according to the invention preferably comprise thoriated tungsten, i.e. tungsten which is doped with thorium oxide, in order to improve the willingness of the high-pressure discharge lamp to start and to reduce the electron work function of the tungsten material.

### III. DESCRIPTION OF THE PREFERRED EXEMPLARY EMBODIMENT

The invention will be explained in more detail below with reference to a preferred exemplary embodiment. In the drawings:

FIG. 1 shows the luminous flux as a function of the operating duration for a high-pressure discharge lamp according to the invention and for a high-pressure discharge lamp in accordance with the prior art,

FIG. 2 shows the running voltage as a function of the operating duration for a high-pressure discharge lamp according to the invention and for a high-pressure discharge lamp in accordance with the prior art,

FIG. 3 shows the change in the color locus as a function of the operating duration for a high-pressure discharge lamp according to the invention and for a high-pressure discharge lamp in accordance with the prior art,

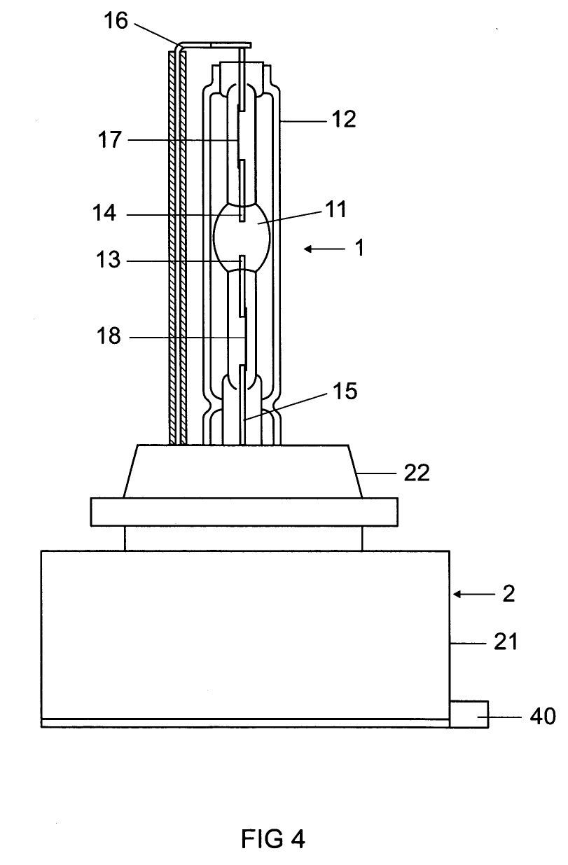

FIG. 4 shows a side view of a high pressure discharge lamp according to the invention,

FIG. 5 shows the luminous flux as a function of the operating duration for a high-pressure discharge lamp in accordance with the second exemplary embodiment of the invention and for a high-pressure discharge lamp in accordance with the prior art,

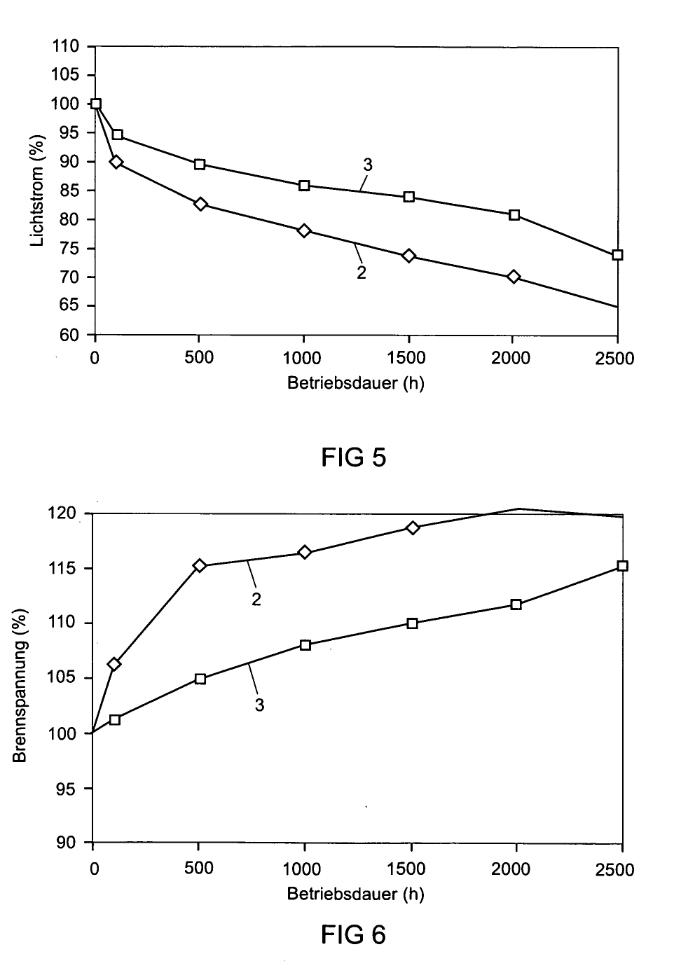

FIG. 6 shows the running voltage as a function of the operating duration for a high-pressure discharge lamp in accordance with the second exemplary embodiment of the invention and for a high-pressure discharge lamp in accordance with the prior art, and

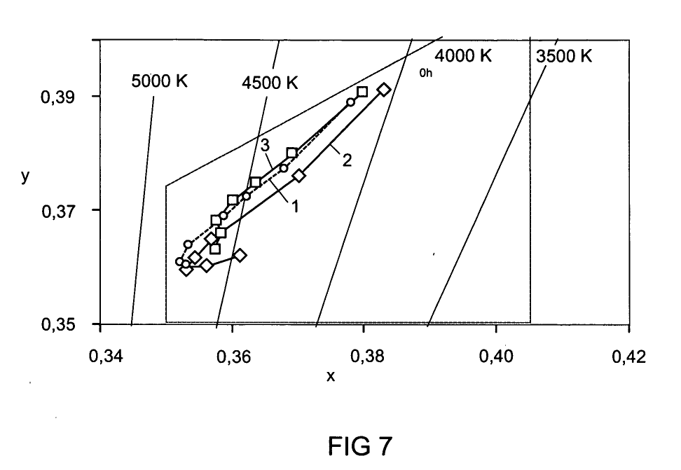

FIG. 7 shows the change in the color locus as a function of the operating duration for high-pressure discharge lamps in accordance with the first (curve 1) and second (curve 3) exemplary embodiment and for a high-pressure discharge lamp in accordance with the prior art (curve 2).

The preferred exemplary embodiment depicted in FIG. 4 of the high-pressure discharge lamp is a metal-halide high-pressure discharge lamp for a motor vehicle headlamp.

This high-pressure discharge lamp has a discharge vessel 11, which is surrounded by a vitreous outer bulb 12, made from quartz glass with electrodes 13, 14 arranged therein made from thoriated tungsten and an ionizable filling for producing a gas discharge. The electrodes 13, 14 are each connected to a power supply line 15 and 16, respectively, which is passed out of the discharge vessel 11 and via which they are supplied with electrical energy. The structural unit 1 comprising the discharge vessel 11 and the outer bulb 12 is fixed in the upper part 22 of the lamp base 2. The lamp base 2 comprises a substantially parallelepipedal base lower part 21 with an electrical connection 40 for supplying voltage to the high-pressure discharge lamp. The components of a pulse starting apparatus for the high-pressure discharge lamp are arranged in the interior of the lower part 21. The two electrodes 13, 14 of the high-pressure discharge lamp are in the form of bars and each have a diameter or a thickness of 0.300 mm. The distance between the discharge-side ends of the electrodes 13, 14 is 4.2 mm. That end of the electrode 13 or 14 which is remote from the discharge side is in each case welded to a molybdenum foil 17 or 18, which is embedded in a gas-tight manner in the respective sealed end of the discharge vessel 11 and produces the electrical connection to the power supply line 15 or 16. The ionizable filling enclosed in the discharge vessel 11 comprises xenon, mercury and metal halides, in particular sodium iodide and scandium iodide as well as possibly halides of further metals.

The measurements in accordance with curve 1 in FIGS. 1 to 3 have each been carried out on the high-pressure discharge lamp in accordance with the preferred exemplary embodiment, whose electrodes (13, 14) have a diameter of 0.300 mm. The comparative measurements according to curve 2 in FIGS. 1 to 3 have been carried out on a generic high-pressure discharge lamp with an electrode diameter of 0.240 mm.

The high-pressure discharge lamp in accordance with the second exemplary embodiment is likewise a metal-halide high-pressure discharge lamp for a motor vehicle headlamp with a rated power of 35 watts. It likewise has the construction depicted in FIG. 4. The only difference from the first exemplary embodiment consists in the fact that the high-pressure discharge lamp in accordance with the second exemplary embodiment has bar-shaped electrodes 13, 14, which have a diameter of in each case 0.265 mm±0.008 mm. FIG. 5 illustrates the decrease in the luminous flux with the operating duration of the high-pressure discharge lamp for the high-pressure discharge lamp in accordance with the second exemplary embodiment and for a high-pressure discharge lamp in accordance with the prior art. The luminous flux as a percentage of the initial luminous flux of the respective high-pressure discharge lamp is plotted on the vertical axis in FIG. 5 as a function of the operating duration in hours. The measurement curve 3 shows the decrease in the luminous flux as a function of its operating duration for the high-pressure discharge lamp in accordance with the second exemplary embodiment, while the measurement curve 2 illustrates the decrease in the luminous flux as a function of its operating duration for a high-pressure discharge lamp in accordance with the prior art. It can be seen that the high-pressure discharge lamp in accordance with the second exemplary embodiment still has 84 percent of its initial luminous flux after an operating duration of 1500 hours, while the high-pressure discharge lamp in accordance with the prior art only still has 74 percent of its initial luminous flux after 1500 operating hours. After an operating duration of 2500 hours, the high-pressure discharge lamp in accordance with the second exemplary embodiment still has 75 percent of its initial luminous flux, while the high-pressure discharge lamp in accordance with the prior art only still has 65 percent of its initial luminous flux after 2500 operating hours. A comparison of measurement curve 1 from FIG. 1 with measurement curve 3 from FIG. 5 shows that the high-pressure discharge lamp in accordance with the second exemplary embodiment demonstrates less of a decrease in the luminous flux after 1500 operating hours than the high-pressure discharge lamp in accordance with the first exemplary embodiment. The measurement curves 2 from FIGS. 1 and 5 originate from the same lamp and therefore correspond to one another for the first 1500 operating hours.

FIG. 6 illustrates, on the vertical axis, the running voltage as a percentage of its initial running voltage for the high-pressure discharge lamp in accordance with the second exemplary embodiment (measurement curve 3) and for the high-pressure discharge lamp in accordance with the prior art (measurement curve 2) as a function of its operating duration in hours. The measurement curve 3 in FIG. 6 shows the change in the running voltage as a function of its operating duration for the high-pressure discharge lamp in accordance with the second exemplary embodiment, while measurement curve 2 illustrates the change in the running voltage as a function of its operating duration for the high-pressure discharge lamp in accordance with the prior art. It can be seen that, in the case of the high-pressure discharge lamp in accordance with the second exemplary embodiment, the running voltage increases to a lesser degree than in the case of the high-pressure discharge lamp in accordance with the prior art during operation. The measurement curves 2 from FIGS. 2 and 6 are identical for the first 1500 operating hours since they originate from the same high-pressure discharge lamp.

FIG. 7 illustrates, for the high-pressure discharge lamps in accordance with the first (curve 1) and second (curve 3) exemplary embodiment and for the high-pressure discharge lamp in accordance with the prior art (curve 2), in addition the change in the color locus of the light emitted by these high-pressure discharge lamps as a function of the operating duration of these high-pressure discharge lamps. The axes in the graph in FIG. 7 correspond to the color coordinates x and y in accordance with the standard chromaticity diagram according to DIN 5033. In FIG. 7, the color loci of the same color temperature for different color temperature values in the range of from 3500 kelvin to 5000 kelvin are illustrated by a plurality of straight lines. The curve 1 shows the displacement of the color locus as a function of the operating duration for the high-pressure discharge lamp in accordance with the first exemplary embodiment, while curve 3 illustrates the displacement of the color locus as a function of the operating duration for the high-pressure discharge lamp in accordance with the second exemplary embodiment and curve 2 illustrates the displacement of the color locus as a function of the operating duration for the high-pressure discharge lamp in accordance with the prior art. The same measurement points as in FIGS. 5 and 6 have been evaluated here, i.e. the measurements were carried out in each case after 0, 100, 500, 1000, 1500, 2000 and 2500 operating hours. According to curve 1 in FIG. 7, the color locus of the white light initially emitted by the high-pressure discharge lamp in accordance with the first exemplary embodiment at the color coordinates of x is approximately equal to 0.378 and of y is approximately equal to 0.39 and the initially emitted light has a color temperature of approximately 4200 kelvin. As the operating duration increases, the color locus of the light emitted by this high-pressure discharge lamp is displaced to color loci with lower values for the color coordinates x and y and the color temperature of the emitted light increases to approximately 4700 kelvin after 1500 operating hours. After 2500 operating hours, the color locus of the high-pressure discharge lamp in accordance with the first exemplary embodiment is still approximately 4700 kelvin and at a further reduced y color coordinate. According to curve 3 in FIG. 7, the color locus of the white light initially emitted by the high-pressure discharge lamp in accordance with the second exemplary embodiment at the color coordinates of x is approximately equal to 0.38 and of y is approximately equal to 0.39 and the initially emitted light has a color temperature of approximately 4200 kelvin. As the operating duration increases, the color locus of the light emitted by this high-pressure discharge lamp is displaced to color loci with lower values for the color coordinates x and y and the color temperature of the emitted light increases to approximately 4600 kelvin after 1500 operating hours. After 2000 and 2500 operating hours, the color temperature is still at approximately 4600 kelvin, but with a further reduced y color coordinate. According to curve 2 in FIG. 7, the color locus of the white light initially emitted by the high-pressure discharge lamp in accordance with the prior art at the color coordinates of x is approximately equal to 0.382 and of y is approximately equal to 0.39 and the initially emitted light has a color temperature of approximately 4100 kelvin. As the operating duration increases, the color locus of the light emitted by the high-pressure discharge lamp in accordance with the prior art is displaced to color loci with lower values for the color coordinates x and y and the color temperature of the emitted light increases to approximately 4700 kelvin after 1500 operating hours. After 2000 and 2500 operating hours, the color temperature decreases again and returns to a value below 4500 kelvin. The curves 1 and 2 from FIG. 3 correspond to the curves 1 and 2 from FIG. 7 at the measurement points for 0, 100, 500, 1000 and 1500 operating hours.

The high-pressure discharge lamp in accordance with the second exemplary embodiment of the invention displays the lowest color locus displacement and the lowest decrease in the luminous flux over the operating duration. For this reason and because the thinner electrodes cause less mechanical stress in the quartz glass of the discharge vessel during production and operation of the high-pressure discharge lamp, the second exemplary embodiment is preferable to the first exemplary embodiment of the invention.

1. A high-pressure discharge lamp with a rated power of less than 50 watts, comprising a discharge vessel made from quartz glass with bar-shaped electrodes arranged therein and an ionizable filling for producing a gas discharge, the ionizable filling comprising mercury, metal halides and noble gas, wherein the bar-shaped electrodes have a thickness in the range of from 0.255 millimeter to 0.350 millimeter.

2. The high-pressure discharge lamp as claimed in claim 1, wherein the electrodes are made from thoriated tungsten.

3. The high-pressure discharge lamp as claimed in claim 2, the thickness of the electrodes being in the range of from 0.255 mm to 0.300 mm.

4. The high-pressure discharge lamp as claimed in claim 1, the thickness of the electrodes being in the range of from 0.255 mm to 0.300 mm
